(19) United States
(12) Patent Application Publication
(10) Pub. No.: US 2012/0222808 A1
(43) Pub. Date: Sep. 6, 2012

(54) MOUNTING DEVICE AND METHOD FOR MANUFACTURING ELECTRONIC MODULE

(75) Inventor: Kazunori HAMAZAKI, Tochigi (JP)

(73) Assignee: SONY CHEMICAL & INFORMATION DEVICE CORPORATION, Tokyo (JP)

(21) Appl. No.: 13/470,349

(22) Filed: May 13, 2012

Related U.S. Application Data
(63) Continuation of application No. PCT/JP2010/004380, filed on Jul. 5, 2010.

(30) Foreign Application Priority Data
Nov. 20, 2009 (JP) 2009-265650

(51) Int. Cl. B32B 37/06; B30B 15/34

(52) U.S. Cl. 156/297; 156/583.1

(57) ABSTRACT

To mount electronic components with different types of electrodes en masse on a substrate, the present invention comprises a heating section that heats an electrode of a first electronic component and an electrode of a second electronic component among the plurality of electronic components; a heat releasing section that releases heat from the electrode of the first electronic component and the electrode of the second electronic component; a first thermally conductive member disposed between the electrode of the first electronic component and the heating section or the heat releasing section; and a second thermally conductive member disposed between the electrode of the second electronic component and the heating section or the heat releasing section. The first thermally conductive member and the second thermally conductive member have different amounts of heat transfer per unit time.

The contents of the following patent applications are incorporated herein by reference:
NO. JP 2009-265650 filed on Nov. 20, 2009 and
NO. PCT/JP2010/004380 filed on Jul. 5, 2010.

### TECHNICAL FIELD

The present invention relates to a mounting device and a method for manufacturing an electronic module.

### BACKGROUND ART

When mounting an electronic component such as a resistor on a substrate such as a circuit board, the electronic component can be mounted by pressing the electronic component and the substrate together and applying heat.

An elastomer is arranged on a head for pressing the electronic component, and a plurality of different types of electronic components can be mounted en masse on the substrate, as described in Patent Documents 1 and 2, for example.
Patent Document 1: Japanese Patent Application Publication No. 2005-32952
Patent Document 2: Japanese Patent Application Publication No. 2007-324413

### DISCLOSURE OF THE INVENTION

### Problems to be Solved by the Invention

The electronic components include electrodes arranged thereon that electrically connect to electrodes of the substrate. However, different types of electrodes of the electronic components have different compression bonding temperatures. Therefore, a method is desired for mounting a plurality of electronic components having different types of electrodes en masse on a substrate. It is an object of an aspect of the innovations herein to provide an electronic component, an electronic component manufacturing method, and a conductive film, which are capable of overcoming the above drawbacks accompanying the related art. The above and other objects can be achieved by combinations described in the independent claims. The dependent claims define further advantageous and exemplary combinations of the innovations herein.

### Means for Solving the Problems

In order to solve the above problems, according to a first aspect of the present invention, provided is a mounting device that bonds a plurality of electronic components to a substrate using thermal compression, comprising a heating section that heats an electrode of a first electronic component and an electrode of a second electronic component among the plurality of electronic components; a heat releasing section that releases heat from the electrode of the first electronic component and the electrode of the second electronic component; a first thermally conductive member disposed between the electrode of the first electronic component and the heating section or the heat releasing section; and a second thermally conductive member disposed between the electrode of the second electronic component and the heating section or the heat releasing section. the first thermally conductive member and the second thermally conductive member have different amounts of heat transfer per unit time.

The mounting device may further comprise a stage on which the substrate is to be loaded; and a head that presses the first electronic component against the substrate via the first thermally conductive member and presses the second electronic component against the substrate via the second thermally conductive member. In the mounting device, the first thermally conductive member and the second thermally conductive member may be formed by an elastomer. In the mounting device the stage may include a first individual stage corresponding to a region where the first thermally conductive member is to be arranged; and a second individual stage corresponding to a region where the second thermally conductive member is to be arranged, and the heating section may heat the electrode of the first electronic component via the first individual stage and heat the electrode of the second electronic component via the second individual stage.

In the mounting device the first thermally conductive member and the second thermally conductive member may have different thermal conduction rates. In the mounting device the amount of heat transfer per unit time of the first thermally conductive member may be determined according to the type of electrode of the first electronic component, and the amount of heat transfer per unit time of the second thermally conductive member may be determined according to the type of electrode of the second electronic component.

According to a second aspect of the present invention, provided is a method for manufacturing an electronic module in which a plurality of electronic components are mounted on a substrate, comprising temperature adjustment of adjusting the temperatures of an electrode of a first electronic component and an electrode of a second electronic component, from among the plurality of electronic components, to be different temperatures; and thermal compression bonding of bonding the first electronic component and the second electronic component to the substrate using thermal compression.

The manufacturing method may be performed by a mounting device including a heating section that heats each electrode of the first electronic component and the second electronic component, a heat releasing section that releases heat from each electrode of the first electronic component and the second electronic component, a first thermally conductive member disposed between the electrode of the first electronic component and the heating section or the heat releasing section, and a second thermally conductive member disposed between the electrode of the second electronic component and the heating section or the heat releasing section, and the first thermally conductive member and the second thermally conductive member may have different amounts of heat transfer per unit time. The temperature adjustment may include adjusting the temperatures of each electrode of the first electronic component and the second electronic component to be a different temperature by heating the electrodes of the first electronic component and the second electronic component with the heating section and releasing heat from the electrodes of the first electronic component and the second electronic component using the heat releasing section.

In the manufacturing method, the mounting device may further includes a stage on which the substrate is to be loaded; and a head that presses the first electronic component against the substrate via the first thermally conductive member and presses the second electronic component against the substrate via the second thermally conductive member. The thermal compression bonding may include loading of loading the substrate on the stage; and pressing of the head pressing the first electronic component against the substrate via the first thermally conductive member and pressing the second electronic component against the substrate via the second thermally conductive member. In the manufacturing method, the first thermally conductive member and the second thermally conductive member may be formed by an elastomer.

The manufacturing method may further comprise film arrangement of, prior to the temperature adjustment, arranging an adhesive film that includes a thermosetting resin between the substrate and the first electronic component and between the substrate and the second electronic component. The thermal compression bonding may include bonding the first electronic component and the second electronic component to the substrate using thermal compression, by thermally hardening the adhesive film.

The summary clause does not necessarily describe all necessary features of the embodiments of the present invention. The present invention may also be a sub-combination of the features described above.

### BRIEF DESCRIPTION OF THE DRAWINGS

FIG. 1 schematically shows an exemplary cross-section of a mounting device 100.

FIG. 2 schematically shows an exemplary cross-section of a mounting device 200.

FIG. 3 schematically shows an exemplary cross-section of a heat transfer unit 330.

FIG. 4 schematically shows an exemplary cross-section of a heat transfer unit 430.

FIG. 5 schematically shows an exemplary cross-section of a mounting device 500.

FIG. 6 shows results of a preliminary experiment according to the first embodiment.

FIG. 7 shows experimental results according to the second embodiment.

FIG. 8 shows experimental results according to the second embodiment.

### BEST MODE FOR CARRYING OUT THE INVENTION

Hereinafter, some embodiments of the present invention will be described. The embodiments do not limit the invention according to the claims, and all the combinations of the features described in the embodiments are not necessarily essential to means provided by aspects of the invention.

The following describes embodiments with reference to the drawings, and portions having the same function or configuration are given the same reference numerals in the drawings and redundant descriptions are omitted. The drawings are merely schematic views, and do not represent actual arrangements, thicknesses, planar dimensions, or relationships therebetween. For ease of explanation, different drawings may include identical portions shown using different dimensional relationships.

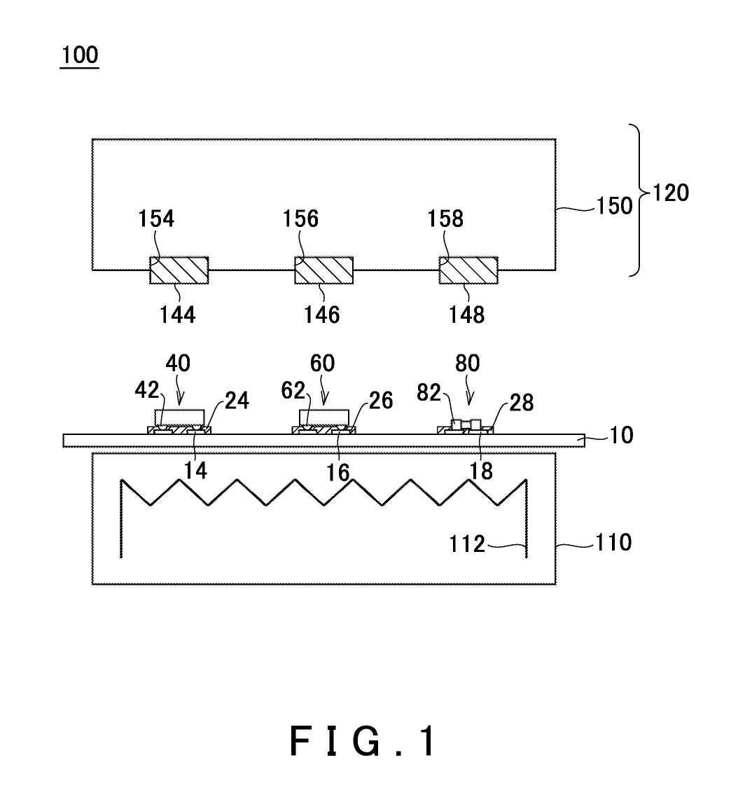

FIG. 1 schematically shows an exemplary cross-section of a mounting device 100. In FIG. 1, the mounting device 100 is shown together with a substrate 10. The mounting device 100 may form an electronic module by mounting a plurality of electronic components on the substrate 10. The mounting device 100 may bond an electronic component 40, an electronic component 60, and an electronic component 80 to the substrate 10 using thermal compression. The electronic component 40, the electronic component 60, and the electronic component 80 are bonded using thermal compression along with a plurality of other electronic components arranged on the substrate 10.

The type of substrate 10 is not particularly limited, and the substrate 10 may be a printed circuit board or a flexible substrate. The types of the electronic component 40, the electronic component 60, and the electronic component 80 are not particularly limited, and these electronic components may be passive components, such as resistors and capacitors, or IC chips. In the present embodiment, the substrate 10 may be a printed circuit board. The electronic component 40 and the electronic component 60 may be IC chips. The electronic component 80 may be a resistor.

The types of the electrodes are not particularly limited. In the present embodiment, the electrode 42 of the electronic component 40 and the electrode 82 of the electronic component 80 may be solder bumps, and the electrode 62 of the electronic component 60 may be a stud bump. In this case, the electronic component 40 and the electronic component 80 are mounted on an electrode 14 and an electrode 18 of the substrate 10 by heating and melting the solders of the electrode 42 and the electrode 82. On the other hand, the electronic component 60 is mounted on an electrode 16 of the substrate 10 by bringing a needle-shaped electrode 62 of the electronic component 60 into contact with the electrode 16 of the substrate 10 and pressing these electrodes together. In this way, the electronic component 60 can be mounted at a lower temperature than the temperature used to mount the electronic component 40 and the electronic component 80.

In the present embodiment, an adhesive film 24, an adhesive film 26, and an adhesive film 28 are respectively arranged between the substrate 10 and the electronic component 40, the electronic component 60, and the electronic component 80. The adhesive film 24, the adhesive film 26, and the adhesive film 28 may be formed by at least a film-forming resin, a liquid hardening component, and a hardening agent. The adhesive film 24, the adhesive film 26, and the adhesive film 28 may include additives such as a variety of rubber components, softening agents, and fillers, and may further include conductive particles.

The film-forming resin may be phenoxy resin, polyester resin, polyamide resin, or polyimide resin, for example. When considering purchasing availability and bonding reliability, phenoxy resin is preferable. The liquid hardening component may be liquid epoxy resin or acrylate, for example. When considering bonding reliability and stability of the hardened material, the liquid hardening component preferably includes two or more functional groups. If the liquid hardening component is liquid epoxy resin, the hardening agent may be imidazole, amine, sulfonium salt, or onium salt. If the liquid hardening component is acrylate, the hardening agent may be an organic oxide compound.

The mounting device 100 may include a stage 110 on which the substrate 10 is loaded and a head unit 120. The stage 110 may include a heating section 112. The heating section 112 may heat the electrodes of the electronic component 40, the electronic component 60, and the electronic component 80. The heating section 112 may include a heater. The heating section 112 may include a plurality of heaters. In this case, each of the heaters may be controlled independently. The heating section 112 may heat the electrode of at least one of the electronic component 40, the electronic component 60, and the electronic component 80. For example, in the present embodiment, the heating section 112 may heat the solder bumps of the electronic component 40 and the electronic component 80.

The head unit 120 may include a thermal conduction member 144, a thermal conduction member 146, a thermal conduction member 148, and a head 150. The head 150 may include a recessed portion 154, a recessed portion 156, and a recessed portion 158 that are formed in the side thereof facing the substrate 10. The head 150 presses the electronic component 40, the electronic component 60, and the electronic component 80 against the substrate 10.

The head 150 may cause the heat in the electrodes of the electronic component 40, the electronic component 60, and the electronic component 80 to be released. The head 150 may cause the heat to be released from the electrodes of the electronic component 40, the electronic component 60, and the electronic component 80 via the thermal conduction member 144, the thermal conduction member 146, and the thermal conduction member 148. The head 150 may be an example of a heat releasing section.

The thermal conduction member 144, the thermal conduction member 146, and the thermal conduction member 148 may be respectively arranged in the recessed portion 154, the recessed portion 156, and the recessed portion 158. When the mounting device 100 performs the thermal compression bonding, the thermal conduction member 144, the thermal conduction member 146, and the thermal conduction member 148 are thermally connected respectively to the electrodes of the electronic component 40, the electronic component 60, and the electronic component 80.

Therefore, by selecting the shape, configuration, and material of the thermal conduction member 144, the thermal conduction member 146, and the thermal conduction member 148, the conductive heat transfer between the head 150 and the electrodes of the electronic component 40, the electronic component 60, and the electronic component 80 can be controlled. The thermal conduction member 144, the thermal conduction member 146, and the thermal conduction member 148 may be replaced according to the type, shape, and size of the mounted electronic components, the position of the electronic components on the substrate, or the method used to connect the electronic components to the substrate.

The thermal conduction member 144 may be arranged such that the release of heat from the electrode 42 of the electronic component 40 occurs mainly through the thermal conduction member 144. In the same manner, the thermal conduction member 146 may be arranged such that the release of heat from the electrode 62 of the electronic component 60 occurs mainly through the thermal conduction member 146. The thermal conduction member 148 may be arranged such that the release of heat from the electrode 82 of the electronic component 80 occurs mainly through the thermal conduction member 148. Therefore, the conductive heat transfer between the head 150 and the electrodes of the electronic component 40, the electronic component 60, and the electronic component 80 can be more accurately controlled.

At least one of the thermal conduction member 144, the thermal conduction member 146, and the thermal conduction member 148 may have a different amount of heat transfer per unit time than another thermal conduction member. For example, at least one of the thermal conduction member 144, the thermal conduction member 146, and the thermal conduction member 148 may have a different thermal conduction rate λ than another thermal conduction member. In this way, the amount of heat transfer per unit time of the thermal conduction member 144, the thermal conduction member 146, and the thermal conduction member 148 can be adjusted.

The amount of heat transfer per unit time of a thermal conduction member can be adjusted using the thermal conduction resistance between the head 150 and the electrode of the electronic component, the temperature difference between the head 150 and the electrode of the electronic component, or the heat transfer surface area between the head 150 and the electrode of the electronic component, for example. The thermal conduction resistance between the head 150 and the electrode of the electronic component can be adjusted using the thermal conduction rate of the thermal conduction member, the thickness of the thermal conduction member, or the configuration of the thermal conduction member.

When the thermal conduction member 144, the thermal conduction member 146, and the thermal conduction member 148 are provided between the head 150 and the electrodes of the electronic components, the temperatures of the electrodes of the electronic components increase more quickly when the thermal conduction members have lower thermal conduction rates λ, when the thermal conduction members have greater thicknesses, when there is a smaller temperature difference between the electrodes of the electronic components and the head 150, and when there is less heat transfer surface area between the thermal conduction members and the electrodes of the electronic components or the head 150.

The amount of heat transfer per unit time of the thermal conduction member 144, the thermal conduction member 146, and the thermal conduction member 148 may be determined according to the types of electrodes of the electronic component 40, the electronic component 60, and the electronic component 80. Therefore, the temperature of each electrode of the electronic component 40, the electronic component 60, and the electronic component 80 can be adjusted to be a different temperature according to the type of the electrode. As a result, defects such as warping of the substrate 10 and damage to the electronic component 40 due to overheating can be restricted.

In the present embodiment, the electrode 42 of the electronic component 40 and the electrode 82 of the electronic component 80 are solder bumps, and the thermal compression is performed at a temperature of approximately 250° C. to melt the solders. On the other hand, the electrode 62 of the electronic component 60 is a stud bump, and thermal compression thereof can be performed at a temperature of approximately 180° C. Therefore, the thermal conduction member 146 may include material with a higher thermal conduction rate λ than the material included in the thermal conduction member 144 and the thermal conduction member 148.

As a result, even when the heating section 112 uniformly heats the substrate 10 or the stage 110 to bond the electronic component 40, the electronic component 60, and the electronic component 80 to the substrate 10 via thermal compression, the amount of heat released through the thermal conduction member 146 from the electrode 62 of the electronic component 60 can be greater than the amount of heat released through the thermal conduction member 144 from the electrode 42 of the electronic component 40 and the amount of heat released through the thermal conduction member 148 from the electrode 82 of the electronic component 80. As a result, the temperature of the electrode 42 of the electronic component 40 can be caused to be lower than the temperature of the electrodes of the electronic component 60 and the electronic component 80.

The temperature of the electrodes of the electronic components is adjusted by adjusting the amount of heat transfer per unit time of the thermal conduction members. Therefore, even if there is a change to the type, shape, or size of the electronic components being mounted, the position of the electronic components on the substrate, or the method for connecting the electronic components to the substrate, it is easy to adapt to this change. Furthermore, even when the number of heaters in the heating section 112 is less than the number of electronic components to be mounted, the temperature of each electrode of the plurality of electronic components can be accurately adjusted to a different temperature.

The present embodiment describes an example in which the temperature of the electrodes of the electronic components is adjusted by adjusting the amount of heat transfer per unit time of the thermal conduction members. However, the method for adjusting the temperature of the electrodes of the electronic components is not limited to this. For example, the heating section 112 may include a plurality of heaters corresponding respectively to the electrodes of the electronic components, and the heaters may be controlled independently to adjust the temperature of each electrode of the electronic components.

At least one of the thermal conduction member 144, the thermal conduction member 146, and the thermal conduction member 148 may include an elastomer such as silicone rubber. At least one of the thermal conduction member 144, the thermal conduction member 146, and the thermal conduction member 148 may include a dilatancy liquid. As a result, when different types of electronic components are mounted on the substrate, a distribution in the pressure applied to the electronic components can be restricted to achieve more uniform pressure on the electronic components.

The surfaces of the thermal conduction member 144, the thermal conduction member 146, and the thermal conduction member 148 facing the substrate 10 may protrude from the surface of the head 150 facing the substrate 10. As a result, the head 150 can press the electronic component 40, the electronic component 60, and the electronic component 80 against the substrate 10 via the thermal conduction member 144, the thermal conduction member 146, and the thermal conduction member 148.

The following describes an exemplary method for manufacturing an electronic module using the mounting device 100. In the present embodiment, first, the substrate 10 is prepared. The substrate 10 can be prepared by arranging the electronic component 40, the electronic component 60, and the electronic component 80 on the substrate 10 such that the electrode 42 of the electronic component 40, the electrode 62 of the electronic component 60, and the electrode 82 of the electronic component 80 can be electrically connected to the electrode 14, the electrode 16, and the electrode 18 of the substrate 10. The adhesive film 24, the adhesive film 26, and the adhesive film 28 are arranged respectively between the substrate 10, the electronic component 40, the electronic component 60, and the electronic component 80.

Next, the prepared substrate 10 is loaded on the stage 110. After this, the head unit 120 is arranged face down on the stage 110, such that the thermal conduction member 144, the thermal conduction member 146, and the thermal conduction member 148 respectively contact the electronic component 40, the electronic component 60, and the electronic component 80. The heating section 112 then heats the electrodes of the electronic component 40, the electronic component 60, and the electronic component 80.

In the present embodiment, the amount of heat transfer of each of the thermal conduction member 144, the thermal conduction member 146, and the thermal conduction member 148 per unit time is determined according to the types of electrodes of the electronic component 40, the electronic component 60, and the electronic component 80. In this way, the thermal conduction member 144, the thermal conduction member 146, and the thermal conduction member 148 are thermally connected to the corresponding electrodes of the electronic component 40, the electronic component 60, and the electronic component 80, thereby enabling each electrode of the electronic component 40, the electronic component 60, and the electronic component 80 to be adjusted to have a different temperature.

Before the head unit 120 is brought into contact with the electronic component 40, the electronic component 60, and the electronic component 80, the heating section 112 may heat the electrodes of the electronic component 40, the electronic component 60, and the electronic component 80 in advance to a temperature that is lower than the compression bonding temperature of the electrode 62 of the electronic component 60. As a result, the compression bonding time can be reduced.

When the electrodes of the electronic component 40, the electronic component 60, and the electronic component 80 reach a prescribed temperature, the head 150 presses the electronic component 40, the electronic component 60, and the electronic component 80 against the substrate 10 via the thermal conduction member 144, the thermal conduction member 146, and the thermal conduction member 148. As a result, the electronic component 40, the electronic component 60, and the electronic component 80 arranged respectively on the adhesive film 24, the adhesive film 26, and the adhesive film 28 can be bonded to the substrate 10 by thermal compression.

In this way, an electronic module in which a plurality of electronic components are mounted on a substrate can be manufactured by using a temperature adjustment step and a thermal compression bonding step. Furthermore, by using thermal conduction members having different amounts of heat transfer per unit time according to the types of electrodes of the electronic components, a plurality of electronic components with different types of electrodes can be mounted en masse on a substrate.

The present embodiment describes an example in which the thermal conduction member 144, the thermal conduction member 146, and the thermal conduction member 148 are arranged between the head 150 and the substrate 10. However, the method for arranging the thermal conduction member 144, the thermal conduction member 146, and the thermal conduction member 148 is not limited to this. For example, the thermal conduction member 144, the thermal conduction member 146, and the thermal conduction member 148 may be arranged between the heating section 112 and the substrate 10.

At this time, the thermal conduction member 144 may be arranged such that the conductive heat transfer from the heating section 112 to the electrode 42 of the electronic component 40 occurs mainly through the thermal conduction member 144. In the same manner, the thermal conduction member 146 may be arranged such that the conductive heat transfer from the heating section 112 to the electrode 62 of the electronic component 60 occurs mainly through the thermal conduction member 146. The thermal conduction member 148 may be arranged such that the conductive heat transfer from the heating section 112 to the electrode 82 of the electronic component 80 occurs mainly through the thermal conduction member 148. Therefore, the conductive heat transfer between the heating section 112 and the electrodes of the electronic component 40, the electronic component 60, and the electronic component 80 can be more accurately controlled.

When the thermal conduction member 144, the thermal conduction member 146, and the thermal conduction member 148 are provided between the heating section 112 and the substrate 10, the temperatures of the electrodes of the electronic components increase more quickly when the thermal conduction members have higher thermal conduction rates λ, when the thermal conduction members have less thicknesses, when there is a greater temperature difference between the electrodes of the electronic components and the heating section 112, and when there is more heat transfer surface area between the thermal conduction members and the electrodes of the electronic components or the heating section 112.

The present embodiment describes an embodiment in which the heating section 112 is arranged in the stage 110. However, the heating section 112 is not limited to this. For example, the heating section 112 may be arranged in the head 150. In this case, the stage 110 may function as the heat releasing section.

The present embodiment describes an example in which the substrate 10 is loaded on the stage 110 such that the surface of the substrate 10 on which the electronic components are not mounted faces the stage 110, and the head 150 is then used to press the electronic components against the substrate 10. However, the mounting device 100 is not limited to this. For example, the substrate 10 may be loaded on the stage 110 such that the surface of the substrate 10 on which the electronic components are mounted faces the stage 110, and the head 150 may then be used to press the substrate 10 against the electronic components. In this case, a dilatancy liquid may be provided on the stage 110.

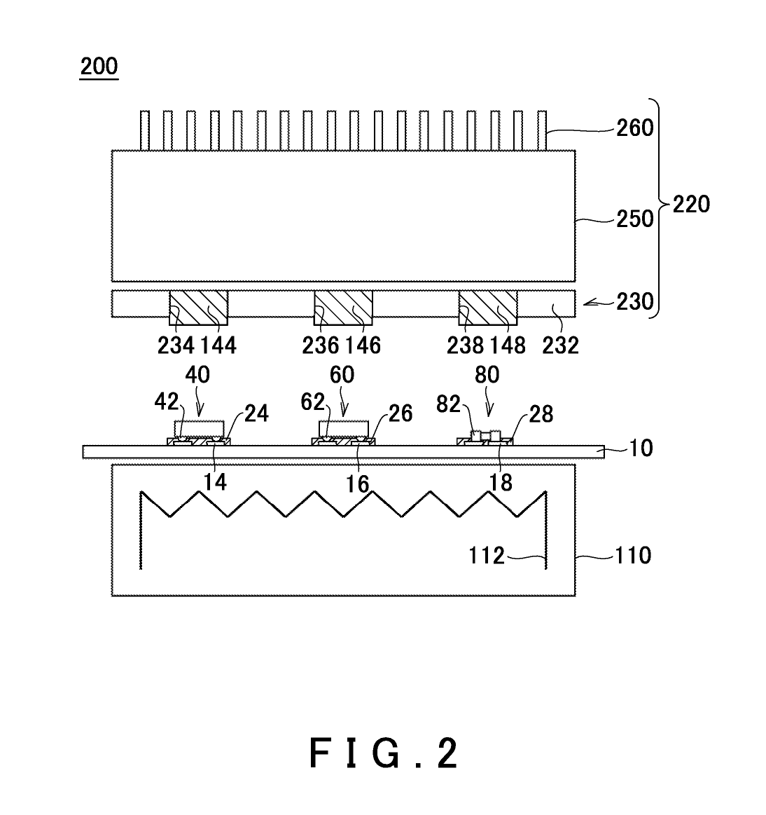

FIG. 2 is a schematic view of an exemplary cross-section of a mounting device 200. In FIG. 2, the mounting device 200 is shown together with a substrate 10. The mounting device 200 may have the same configuration as the mounting device 100, except that the mounting device 200 includes a head unit 220 instead of the head unit 120. The following description of the mounting device 200 focuses on the difference between the head unit 220 and the head unit 120, and redundant descriptions are omitted.

The head unit 220 may include a heat transfer unit 230, a head 250, and a heat releasing board 260. The heat transfer unit 230 may be freely detachable from the head unit 220. Therefore, the heat transfer unit 230 can be easily replaced according to the type, shape, and size of the electronic components being mounted, the position of the electronic components on the substrate, or the method used to connect the electronic components to the substrate.

In the present embodiment, the heat transfer unit 230 may be arranged between the heat releasing board 260 and the substrate 10. The heat transfer unit 230 may include a support portion 232, the thermal conduction member 144, the thermal conduction member 146, and the thermal conduction member 148.

The support portion 232 supports the thermal conduction member 144, the thermal conduction member 146, and the thermal conduction member 148. The support portion 232 may include a through-hole 234, a through-hole 236, and a through-hole 238. The thermal conduction member 144, the thermal conduction member 146, and the thermal conduction member 148 may be respectively arranged in the through-hole 234, the through-hole 236, and the through-hole 238.

The present embodiment describes an example in which the thermal conduction member 144, the thermal conduction member 146, and the thermal conduction member 148 are arranged in the through-holes formed in the support portion 232. However, the method for arranging the thermal conduction member 144, the thermal conduction member 146, and the thermal conduction member 148 is not limited to this. For example, the thermal conduction member 144, the thermal conduction member 146, and the thermal conduction member 148 may be arranged in recessed portions formed in the support portion 232.

The support portion 232 may release heat from the electrodes of the electronic component 40, the electronic component 60, and the electronic component 80. The support portion 232 may release heat from the electrodes of the electronic component 40, the electronic component 60, and the electronic component 80 through the thermal conduction member 144, the thermal conduction member 146, and the thermal conduction member 148. The support portion 232 may be an example of a heat releasing section.

In this case, the support portion 232 may be formed of a material with a higher thermal conduction rate λ than the material of at least one of the thermal conduction member 144, the thermal conduction member 146, and the thermal conduction member 148. As a result, the movement of the heat released from the electronic component through the thermal conduction member having a lower thermal conduction rate λ than the support portion 232 can be prevented from having a higher rate than the heat transfer in the support portion 232.

On the other hand, in the present embodiment, the thermal conduction member 144, the thermal conduction member 146, and the thermal conduction member 148 are respectively arranged in the through-hole 234, the through-hole 236, and the through-hole 238. The support portion 232 may be formed by a material with thermal insulating properties. The support portion 232 may be formed by material having a lower thermal conduction rate λ than the material of at least one of the thermal conduction member 144, the thermal conduction member 146, and the thermal conduction member 148.

In this way, the conductive thermal transfer from the side surfaces of the through-hole 234, the through-hole 236, and the through-hole 238 can be restricted. As a result, the conductive thermal transfer between the heat releasing board 260 and the electrodes of the electronic component 40, the electronic component 60, and the electronic component 80 can be more accurately controlled by selecting the shape, configuration, or material of the thermal conduction member 144, the thermal conduction member 146, and the thermal conduction member 148.

In the present embodiment, the thermal conduction member 144, the thermal conduction member 146, and the thermal conduction member 148 may be respectively provided between the heat releasing board 260 and the electrode 42 of the electronic component 40, the electrode 62 of the electronic component 60, and the electrode 82 of the electronic component 80. As a result, the conductive thermal transfer between the heat releasing board 260 and the electrodes of the electronic component 40, the electronic component 60, and the electronic component 80 can be controlled by selecting the shape, configuration, or material of the thermal conduction member 144, the thermal conduction member 146, and the thermal conduction member 148.

The thermal conduction member 144 may be arranged such that the release of heat from the electrode 42 of the electronic component 40 to the heat releasing board 260 occurs mainly through the thermal conduction member 144. In the same manner, the thermal conduction member 146 may be arranged such that the release of heat from the electrode 62 of the electronic component 60 to the heat releasing board 260 occurs mainly through the thermal conduction member 146. The thermal conduction member 148 may be arranged such that the release of heat from the electrode 82 of the electronic component 80 to the heat releasing board 260 occurs mainly through the thermal conduction member 148. Therefore, the conductive heat transfer between the heat releasing board 260 and the electrodes of the electronic component 40, the electronic component 60, and the electronic component 80 can be more accurately controlled.

When the heat transfer unit 230 is provided between the heat releasing board 260 and the electrodes of the electronic components, the temperatures of the electrodes of the electronic components increase more quickly when the thermal conduction members have lower thermal conduction rates λ, when the thermal conduction members have greater thicknesses, when there is a smaller temperature difference between the electrodes of the electronic components and the heat releasing board 260, and when there is less heat transfer surface area between the thermal conduction members and the electrodes of the electronic components or the heat releasing board 260.

The head 250 may press the electronic components against the substrates 10 via the heat transfer unit 230. In this way, the head 250 can press the electronic component 40 against the substrate 10 via the thermal conduction member 144. The head 250 can press the electronic component 60 against the substrate 10 via the thermal conduction member 146. The head 250 can press the electronic component 80 against the substrate 10 via the thermal conduction member 148.

The head 250 may release heat from the electrodes of the electronic component 40, the electronic component 60, and the electronic component 80. The head 250 may release heat from the electrodes of the electronic component 40, the electronic component 60, and the electronic component 80 respectively through the thermal conduction member 144, the thermal conduction member 146, and the thermal conduction member 148. The head 250 may be an example of a heat releasing section.

The heat releasing board 260 may release heat from the electrodes of the electronic component 40, the electronic component 60, and the electronic component 80. The heat releasing board 260 may disperse heat from the electrodes of the electronic component 40, the electronic component 60, and the electronic component 80 respectively through the thermal conduction member 144, the thermal conduction member 146, and the thermal conduction member 148. The heat releasing board 260 may be an example of a heat releasing section. As another example of a heat releasing section, a heat exchanger may be used.

The heat releasing board 260 may be provided on in the head 250 to cool the head 250. The arrangement and cooling capability of the heat releasing board 260 may be changed according to the type, shape, and size of the electronic components to be mounted, the position of the electronic components on the substrate, or the method used to connect the electronic components to the substrate. The cooling capability of the heat releasing board 260 can be changed by altering the material or the size of the heat releasing board 260, for example.

The present embodiment describes an example in which the heat transfer unit 230 is arranged between the heat releasing board 260 and the substrate 10. However, the heat transfer unit 230 is not limited to this. For example, the heat transfer unit 230 may be provided between the heating section 112 and the substrate 10. In this case, the thermal conduction member 144, the thermal conduction member 146, and the thermal conduction member 148 are respectively arranged between the heating section 112 and the electrode 42 of the electronic component 40, the electrode 62 of the electronic component 60, and the electrode 82 of the electronic component 80.

The thermal conduction member 144 may be arranged such that the conductive heat transfer from the heating section 112 to the electrode 42 of the electronic component 40 occurs mainly through the thermal conduction member 144. In the same manner, the thermal conduction member 146 may be arranged such that the conductive heat transfer from the heating section 112 to the electrode 62 of the electronic component 60 occurs mainly through the thermal conduction member 146. The thermal conduction member 148 may be arranged such that the conductive heat transfer from the heating section 112 to the electrode 82 of the electronic component 80 occurs mainly through the thermal conduction member 148. Therefore, the conductive heat transfer between the heating section 112 and the electrodes of the electronic component 40, the electronic component 60, and the electronic component 80 can be more accurately controlled.

When the heat transfer unit 230 is provided between the heating section 112 and the substrate 10, the temperatures of the electrodes of the electronic components increase more quickly when the thermal conduction members have higher thermal conduction rates λ, when the thermal conduction members have less thicknesses, when there is a greater temperature difference between the electrodes of the electronic components and the heating section 112, and when there is more heat transfer surface area between the thermal conduction members and the electrodes of the electronic components or the heating section 112.

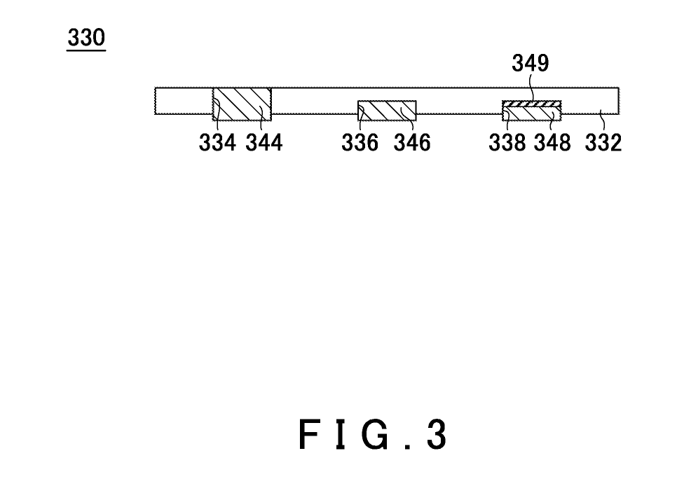

FIG. 3 is a schematic view of an exemplary cross-section of a heat transfer unit 330. The heat transfer unit 330 may include a support portion 332, a thermal conduction member 344, a thermal conduction member 346, and a layered structure including a thermal conduction member 348 and a thermal conduction member 349. The heat transfer unit 330, the support portion 332, the thermal conduction member 344, the thermal conduction member 346, and the layered structure including the thermal conduction member 348 and the thermal conduction member 349 respectively correspond to the heat transfer unit 230, the support portion 232, the thermal conduction member 144, the thermal conduction member 146, and the thermal conduction member 148.

These corresponding components may have the same configurations. Accordingly, the following description of the heat transfer unit 330 and the components thereof focuses on the differences with respect to the heat transfer unit 230 and the components thereof, and redundant descriptions are omitted.

The support portion 332 may include a through-hole 334, a recessed portion 336, and a recessed portion 338. The thermal conduction member 344 and the thermal conduction member 346 may be arranged respectively in the through-hole 334 and the recessed portion 336. The thickness of the thermal conduction member 344 is greater than the thickness of the thermal conduction member 346. As a result, even when the thermal conduction member 344 and the thermal conduction member 346 are formed of the same material, the thermal conduction member 344 and the thermal conduction member 346 have different amounts of heat transfer per unit time.

The thermal conduction member 348 and the thermal conduction member 349 may be layered in the recessed portion 338, thereby forming the layered structure including the thermal conduction member 348 and the thermal conduction member 349. The thermal conduction member 348 and the thermal conduction member 349 may be made of the same material or different material. Even if the thermal conduction member 348 and the thermal conduction member 349 are formed of the same material, the thermal resistance at the interface between the thermal conduction member 348 and the thermal conduction member 349 causes the layered structure to have a different amount of heat transfer per unit time than a thermal conduction member having the same thickness as the layered structure. As a result, even when the thickness of the thermal conduction member 346 is the same as the thickness of the layered structure including the thermal conduction member 348 and the thermal conduction member 349, the layered structure including the thermal conduction member 348 and the thermal conduction member 349 has a different amount of heat transfer per unit time than the thermal conduction member 346.

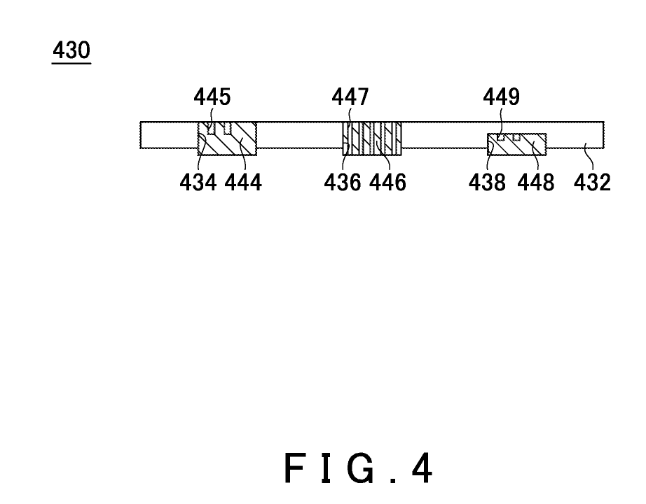

FIG. 4 is a schematic view of an exemplary cross-section of a heat transfer unit 430. The heat transfer unit 430 may include a support portion 432, a thermal conduction member 444, a thermal conduction member 446, and a thermal conduction member 448. The heat transfer unit 430, the support portion 432, the thermal conduction member 444, and the thermal conduction member 446 respectively correspond to the heat transfer unit 230 or heat transfer unit 330, the support portion 232 or support portion 332, the thermal conduction member 144 or thermal conduction member 344, and the thermal conduction member 146 or thermal conduction member 346. The thermal conduction member 448 corresponds to the thermal conduction member 148 or the layered structure including the thermal conduction member 348 and the thermal conduction member 349.

These corresponding components may have the same configurations. Accordingly, the following description of the heat transfer unit 430 and the components thereof focuses on the differences with respect to the heat transfer unit 230 or the heat transfer unit 330 and the components thereof, and redundant descriptions are omitted.

The support portion 432 may include a through-hole 434, a through-hole 436, and a recessed portion 438. The thermal conduction member 444, the thermal conduction member 446, and the thermal conduction member 448 may be arranged respectively in the through-hole 434, the through-hole 436, and the recessed portion 438.

The thermal conduction member 444 may include a recessed portion 445 in the surface thereof facing the head 250. Therefore, there is less heat transfer surface area between the thermal conduction member 444 and the head 250 than in a case where the recessed portion 445 is not formed. As a result, the thermal conduction member 444 has less heat transfer per unit time than in a case where the recessed portion 445 is not formed.

The thermal conduction member 446 may include a through-hole 447. Therefore, there is less heat transfer surface area between the thermal conduction member 446 and the head 250 and between the thermal conduction member 446 and the electronic component than in a case where the through-hole 447 is not formed. As a result, the thermal conduction member 446 has less heat transfer per unit time than in a case where the through-hole 447 is not formed.

The thermal conduction member 448 may include a recessed portion 449 in the surface thereof facing the recessed portion 438. Therefore, there is less heat transfer surface area between the thermal conduction member 448 and the support portion 432 than in a case where the recessed portion 449 is not formed. As a result, the thermal conduction member 448 has less heat transfer per unit time than in a case where the recessed portion 449 is not formed.

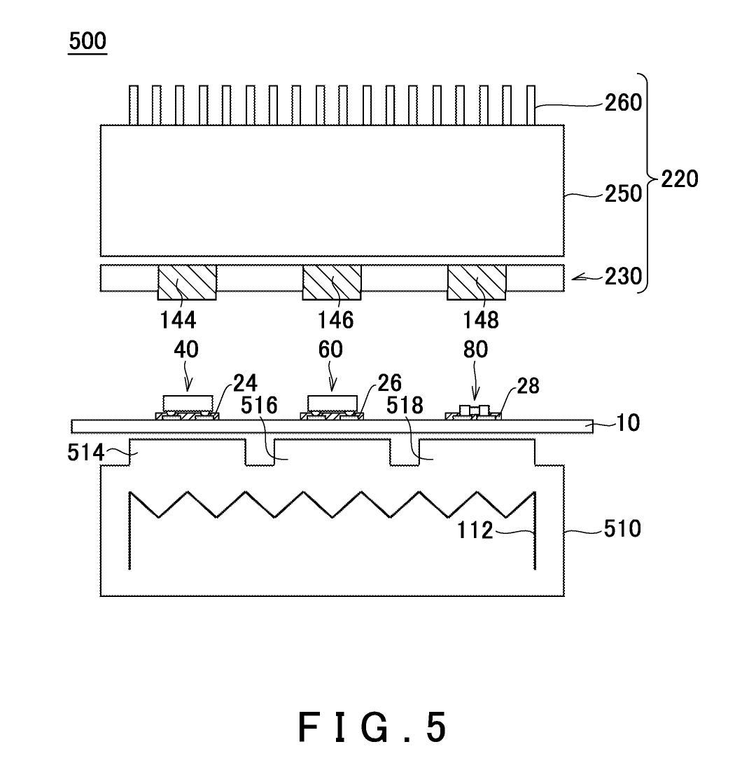

FIG. 5 is a schematic view of an exemplary cross-section of a mounting device 500. FIG. 5 shows the mounting device 500 together with the substrate 10. The mounting device 500 may have the same configuration as the mounting device 200, except that the stage 510 of the mounting device 500 differs from the stage 110. The following description of the mounting device 500 focuses on the difference between the stage 510 and the stage 110, and redundant descriptions are omitted.

The stage 510 includes a heating section 112, an individual stage 514, an individual stage 516, and an individual stage 518. The individual stage 514 corresponds to a region in which the electronic component 40 is arranged. The individual stage 516 corresponds to a region in which the electronic component 60 is arranged. The individual stage 518 corresponds to a region in which the electronic component 80 is arranged.

In the present embodiment, the heating section 112 heats the electrode 42 of the electronic component 40 via the individual stage 514. The heating section 112 heats the electrode 62 of the electronic component 60 via the individual stage 516. The heating section 112 heats the electrode 82 of the electronic component 80 via the individual stage 518. As a result, warping of the substrate 10, the electronic component 40, the electronic component 60, and the electronic component 80 due to the compression bonding can be restricted. The surface area of each individual stage may be no less than 1.3 times and no greater than 6.5 times the surface area of the corresponding electronic component. As a result, warping of the electronic components and the substrate can be effectively restricted.

### EMBODIMENTS

### First Embodiment

Using a head on which is formed rubber having a thermal conduction rate λ of 3.0 W/mK and rubber having a thermal conduction rate λ of 0.21 W/mK, an LSI including Au stud bumps and an LSI including solder bumps were mounted on a printed circuit board with a thickness of 0.2 mm. A non-conductive film (NCF) with a thickness of 50 μm was arranged between the printed circuit substrate and each of the LSI including the Au stud bumps and the LSI including a solder bumps. The NCF included a thermosetting resin and a hardening agent, and hardening was begun when the temperature was increased to be greater than or equal to the hardening temperature. As a result, the back surfaces of the LSIs were adhered to the printed circuit substrate by the NCF, thereby fixing the LSIs on the printed circuit substrate.

The NCF was manufactured using the following process. First, 10 parts by mass of phenoxy resin (YP50 manufactured by Tohto Kasei Co., Ltd), 10 parts by mass of liquid epoxy resin (EP828 manufactured by Japan Epoxy Resin Co., Ltd), 15 parts by mass of an imidazole latent hardening agent (Novacure 3941HP manufactured by Asahi Kasei Corporation), 5 parts by mass of a rubber component (RKB manufactured by Resinous Kasei Co., Ltd), 50 parts by mass of inorganic filler (SOE2 manufactured by Admatechs Co., Ltd), and 1 part by mass of a silane coupling agent (A-187 manufactured by Momentive Performance Materials Co., Ltd) were stirred with 100 parts by mass of toluene, to create a uniform resin solution.

Next, the resin solution was applied on a peeling base material using a bar coater, and the solvent was vaporized and dried in a heating oven at 80° C. The material used for the peeling base material was polyethylene trephthalate. In this way, an NCF was obtained having a peeling base material on one side thereof. This NCF was affixed on a printed circuit substrate using the following process. First, the NCF was cut to have a prescribed shape, along with the peeling base material. Next, the NCF was tentatively affixed on the printed circuit substrate and the peeling base material was then peeled off, thereby affixing the NCF to the printed circuit substrate.

A piece of rubber having a thermal conduction rate λ of 3.0 W/mK and a piece rubber having a thermal conduction rate λ of 0.21 W/mK that each have a square planar shape in which each side is 50 mm and a thickness of 5 mm were used. An LSI including Au stud bumps and an LSI including solder bumps that each have a square planar shape in which each side is 6.3 mm, a thickness of 0.2 mm, and Au stud bumps or solder bumps arranged on the back surface thereof with a pitch of 85 μm were used.

The LSI including the Au stud bumps was pressed against the printed circuit board via the piece of rubber having a thermal conduction rate λ of 3.0 W/mK. The LSI including the solder bumps was pressed against the printed circuit board via the piece of rubber having a thermal conduction rate λ of 0.21 W/mK. The heating section was set such that the temperature of the stage was 265° C. The compression time was set to be 20 seconds. As a result, the Au stud bumps of the LSI including the Au stud bumps were electrically connected to electrodes of the printed circuit substrate. Furthermore, the solder bumps of the LSI including the solder bumps were electrically connected to electrodes of the printed circuit board.

The thermal conduction rate λ and compression time for each piece of rubber was determined according to the types of bumps on the corresponding LSI. To determine the thermal conduction rate λ for each piece of rubber, a head including a piece of rubber having a thermal conduction rate λ of 5.0 W/mK, a piece of rubber having a thermal conduction rate λ of 3.0 W/mK, and a piece of rubber having a thermal conduction rate λ of 0.21 W/mK was used to perform a preliminary experiment in advance. In this preliminary experiment, the thickness and planar shape of each piece of rubber, the thicknesses of the NCF and the printed circuit board, and the setting of the heating section were the same as in the first embodiment. The head on which these pieces of rubber were arranged was pressed against the printed circuit board, and the change over time of the temperature of the printed circuit board in regions respectively contacting the pieces of rubber was measured.

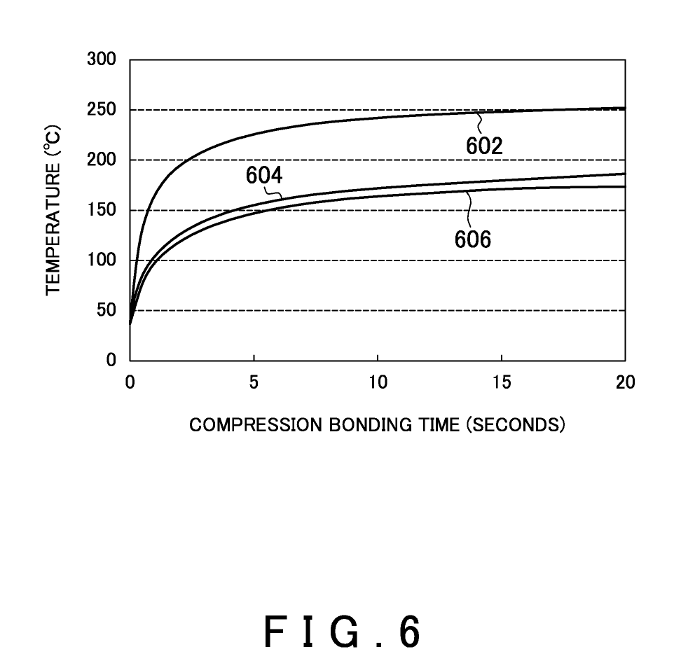

FIG. 6 shows results of the preliminary experiment. The horizontal axis of FIG. 6 represents the time in seconds that has passed from when the compression bonding was begun, which is referred to as the “compression bonding time.” The vertical axis of FIG. 6 represents the temperature in degrees Celsius at each region of the printed circuit substrate.

The curve 602 indicates change over time of the temperature of the region contacting the piece of rubber having a thermal conduction rate λ of 0.21 W/mK. When the compression time exceeded 15 seconds, the rate at which the temperature increases became lower. When the compression time was 20 seconds, the temperature was 250° C. The curve 604 indicates change over time of the temperature of the region contacting the piece of rubber having a thermal conduction rate λ of 3.0 W/mK. When the compression time exceeded 15 seconds, the rate at which the temperature increases became lower. When the compression time was 20 seconds, the temperature was 185° C. The curve 606 indicates change over time of the temperature of the region contacting the piece of rubber having a thermal conduction rate λ of 5.0 W/mK. When the compression time exceeded 15 seconds, the rate at which the temperature increases became lower. When the compression time was 20 seconds, the temperature was 175° C.

The Au stud bumps can be compression bonded at a temperature from 180° C. to 185° C. The solder bumps can be compression bonded at a temperature of approximately 250° C. Based on the results of the preliminary experiment shown in FIG. 6, the compression bonding time was determined to be 20 seconds. Furthermore, the thermal conduction rates λ for the two pieces of rubber were determined to be 3.0 W/mK and 0.21 W/mK.

After the compression bonding, the conduction resistance between the electrodes of the printed circuit substrate and the bumps of the LSIs was measured for each LSI. The conduction resistance was measured using the four terminal technique. The conduction resistance was determined as the average of two measured values. The conduction resistance between the electrodes of the printed circuit board and the Au stud bumps of the LSI including Au stud bumps was 0.11Ω, and this value is sufficiently low. The conduction resistance between the electrodes of the printed circuit board and the solder bumps of the LSI including solder bumps was 0.10Ω, and this value is sufficiently low. Based on the results of the first embodiment, it is understood that both LSIs were successfully mounted.

The pieces of rubber may be examples of thermal conduction members. Accordingly, based on the results of the first embodiment, it is understood that a plurality of electronic components having different types of electrodes can be mounted on the substrate by using thermal conduction members with different amounts of heat transfer per unit time to adjust the electrodes of the electronic components to be different temperatures.

### Second Embodiment

The size of the stage was changed and an LSI having a square planar shape in which each edge is 6.3 mm, a thickness of 0.2 mm, and Au stud bumps arranged on the back surface with a pitch of 150 μm was mounted on a printed circuit board with a thickness of 0.6 mm. A non-conductive film (NCF) with a thickness of 50 μm was used as the LSI and mounted on the printed circuit board. A Teflon (registered trademark) sheet with a thickness of 0.05 mm was arranged between the head and the LSI, and compression bonding was then performed.

The compression bonding was performed using the following process. First, the LSI was tentatively compression bonded to the printed circuit board with a temperature of 60° C., a pressure of 5 kgf, and a compression bonding time of 3 seconds. Next, the LSI was compression bonded to the printed circuit substrate with a temperature of 180° C., a pressure of 10 kgf, and a compression bonding time of 20 seconds. Experimentation using the same conditions was performed for a plurality of stages having square planar shapes in which each edge was respectively 7 mm, 15 mm, 20 mm, and 40 mm.

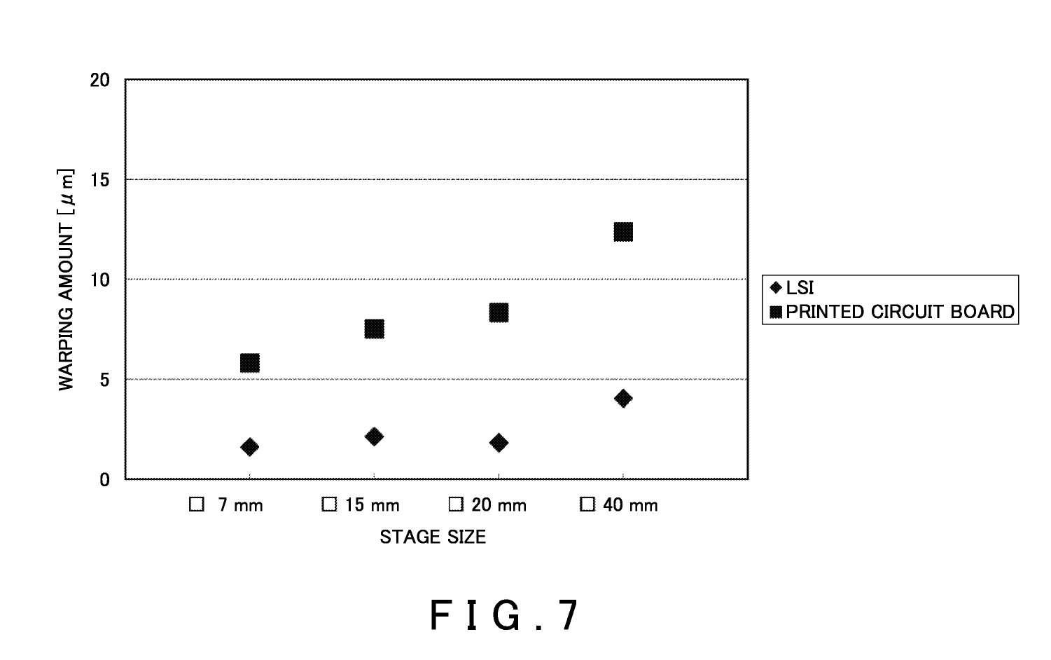

FIG. 7 shows the relationship between size of the stage and the amount of warping of the printed circuit substrate and the LSI. The horizontal axis in FIG. 7 represents the size of the stage. The vertical axis in FIG. 7 represents the amount of warping of the printed circuit substrate and the LSI. The warping amount is positive when the central portions of the printed circuit substrate and LSI are raised up, and the warping amount is negative when the edge portions of the printed circuit substrate and LSI are raised up. In FIG. 7, the points plotted with squares indicate the warping amount of the printed circuit board, and the points plotted with diamonds indicate the warping amount of the LSI.

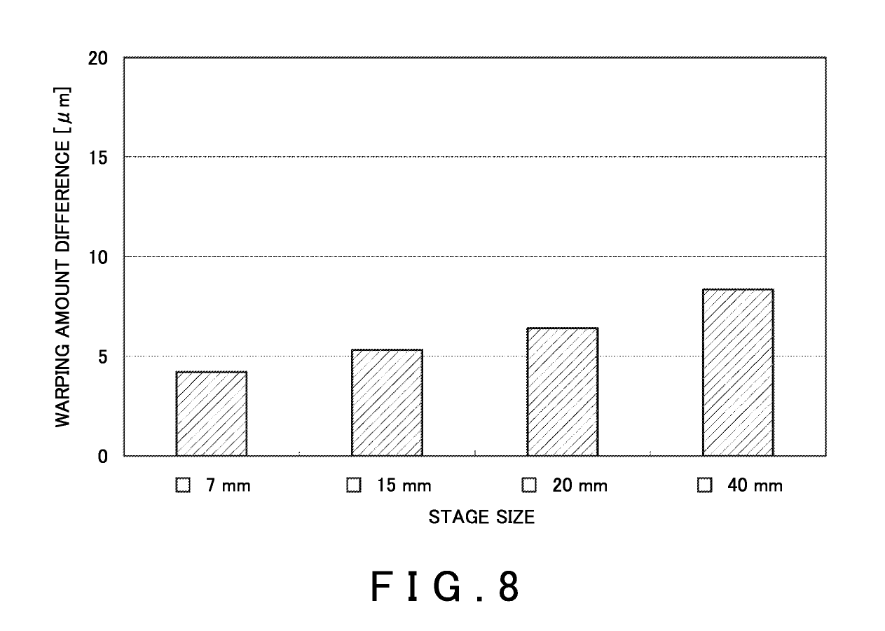

FIG. 8 shows the relationship between size of the stage and the amount of warping of the printed circuit substrate and the LSI. The difference in warping amount can be calculated based on the experimental results of FIG. 7 by subtracting the warping amount of the printed circuit board from the warping amount of the LSI for each of the stages having edges that are respectively 7 mm, 15 mm, 20 mm, and 40 mm.

As shown in FIGS. 7 and 8, the warping amounts of the printed circuit boards and the LSIs were kept low in all cases. Based on these results, it is understood that warping amounts of printed circuit boards and LSIs can be reduced by reducing the size of the stage. Therefore, it is understood that the warping amounts of substrates and electronic components can be reduced by providing individual stages corresponding to the electronic components on the stage.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### LIST OF REFERENCE NUMERALS

10: substrate; 14, 16, 18: electrode; 24, 26, 28: adhesive film; 40: electronic component; 42: electrode; 60: electronic component; 62: electrode; 80: electronic component; 82: electrode; 100: mounting device; 110: stage; 112: heating section; 120: head unit; 144, 146, 148: thermal conduction member; 150: head; 154, 156, 158: recessed portion; 200: mounting device; 220: head unit; 230: heat transfer unit; 232: support portion; 234, 236, 238: through-hole; 250: head; 260: heat releasing board; 330: heat transfer unit; 332: support portion; 334: through-hole; 336, 338: recessed portion; 344, 346, 348, 349: thermal conduction member; 430: heat transfer unit; 432: support portion; 434, 436: through-hole; 438: recessed portion; 444: thermal conduction member; 445: recessed portion; 446: thermal conduction member; 447: through-hole; thermal conduction member thermal conduction member; 449: recessed portion; 500: mounting device; 510: stage; 514, 516, 518: individual stage; 602, 604, 606: curve

1. A mounting device that bonds a plurality of electronic components to a substrate using thermal compression, comprising:
a heating section that heats an electrode of a first electronic component and an electrode of a second electronic component among the plurality of electronic components;
a heat releasing section that releases heat from the electrode of the first electronic component and the electrode of the second electronic component;
a first thermally conductive member disposed between the electrode of the first electronic component and the heating section or the heat releasing section; and
a second thermally conductive member disposed between the electrode of the second electronic component and the heating section or the heat releasing section, wherein
the first thermally conductive member and the second thermally conductive member have different amounts of heat transfer per unit time.

2. The mounting device according to claim 1, further comprising:
a stage on which the substrate is to be loaded; and
a head that presses the first electronic component against the substrate via the first thermally conductive member and presses the second electronic component against the substrate via the second thermally conductive member.

3. The mounting device according to claim 2, wherein
the first thermally conductive member and the second thermally conductive member are formed by an elastomer.

4. The mounting device according to claim 2, wherein
the stage includes:
a first individual stage corresponding to a region where the first thermally conductive member is to be arranged; and
a second individual stage corresponding to a region where the second thermally conductive member is to be arranged, and
the heating section heats the electrode of the first electronic component via the first individual stage and heats the electrode of the second electronic component via the second individual stage.

5. The mounting device according to claim 1, wherein
the first thermally conductive member and the second thermally conductive member have different thermal conduction rates.

6. The mounting device according to claim 1, wherein
the amount of heat transfer per unit time of the first thermally conductive member is determined according to the type of electrode of the first electronic component, and
the amount of heat transfer per unit time of the second thermally conductive member is determined according to the type of electrode of the second electronic component.

7. A method for manufacturing an electronic module in which a plurality of electronic components are mounted on a substrate, comprising:
temperature adjustment of adjusting the temperatures of an electrode of a first electronic component and an electrode of a second electronic component, from among the plurality of electronic components, to be different temperatures; and
thermal compression bonding of bonding the first electronic component and the second electronic component to the substrate using thermal compression.

8. The manufacturing method according to claim 7, wherein
the method is performed by a mounting device including a heating section that heats each electrode of the first electronic component and the second electronic component, a heat releasing section that releases heat from each electrode of the first electronic component and the second electronic component, a first thermally conductive member disposed between the electrode of the first electronic component and the heating section or the heat releasing section, and a second thermally conductive member disposed between the electrode of the second electronic component and the heating section or the heat releasing section,
the first thermally conductive member and the second thermally conductive member have different amounts of heat transfer per unit time, and
the temperature adjustment includes adjusting the temperatures of each electrode of the first electronic component and the second electronic component to be a different temperature by heating the electrodes of the first electronic component and the second electronic component with the heating section and releasing heat from the electrodes of the first electronic component and the second electronic component using the heat releasing section.

9. The manufacturing method according to claim 8, wherein
the mounting device further includes:
a stage on which the substrate is to be loaded; and
a head that presses the first electronic component against the substrate via the first thermally conductive member and presses the second electronic component against the substrate via the second thermally conductive member, and
the thermal compression bonding includes:
loading of loading the substrate on the stage; and
pressing of the head pressing the first electronic component against the substrate via the first thermally conductive member and pressing the second electronic component against the substrate via the second thermally conductive member.

10. The manufacturing method according to claim 9, wherein
the first thermally conductive member and the second thermally conductive member are formed by an elastomer.

11. The manufacturing method according to claim 7, further comprising film arrangement of, prior to the temperature adjustment, arranging an adhesive film that includes a thermosetting resin between the substrate and the first electronic component and between the substrate and the second electronic component, wherein
the thermal compression bonding includes bonding the first electronic component and the second electronic component to the substrate using thermal compression, by thermally hardening the adhesive film.
